(19) United States
(12) Patent Application Publication
(10) Pub. No.: US 2007/0271079 A1
(43) Pub. Date: Nov. 22, 2007

(54) Simulator for Vehicle Radio Propagation Including Shadowing Effects

(76) Inventors: Kentaro Oguchi, Menlo Park, CA (US); Edward L. Koch, San Rafael, CA (US); Wesley C. Collier, Piedmont, CA (US); Rama K. Vuyyuru, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/690,802

(22) Filed: Mar. 23, 2007

Related U.S. Application Data
(60) Provisional application No. 60/747,508, filed on May 17, 2006.

(51) Int. Cl. G06G 7/48

(52) U.S. Cl. 703/8

(57) ABSTRACT

A simulator for inter-vehicle radio communication includes terrain and building data and can simulate the effects of buildings in terrain on radio propagation. The simulator also models other vehicles and the shadow effects of their presence. The system comprises a simulation engine, a network simulator, a driving simulator, a database and a user interface module adapted for communication. The simulation engine simulates the propagation of communication signals between vehicles including the effects of shadowing, and also receives data from the network simulator, the driving simulator and database to generate the propagation simulation. The simulation engine outputs the results of the propagation simulation to the user interface module which translates the information into various displays. The present invention is particularly advantageous because it provides a variety of different user interfaces to show the effective range/propagation of communication signals for different conditions including vehicle locations, terrain, vehicle movements, data traffic and networks configuration.

### CROSS-REFERENCE TO RELATED APPLICATION

This application claims priority under 35 U.S.C. § 119(e) to U.S. Provisional Patent Application Ser. No. 60/747,508, entitled “Simulator For Auto-mesh Radio Propagation Including Shadowing Effects Of Vehicles,” filed May 17, 2006, which is incorporated herein by reference.

### BACKGROUND OF THE INVENTION

1. Field of the Invention

This invention relates generally to systems and methods for simulating communication signals and networks. More particularly, the present invention is related to systems and methods for simulating the propagation of radio signals including the effects of shadowing in vehicular networks.

2. Description of the Related Art

Vehicular communication technology has the potential to provide safety, comfort and entertainment for every driver on the road. Automobile manufacturers and the networking research community are attempting to develop new technologies and equipment for vehicular communication. However, due to the infrastructure requirements and deployment costs it is not feasible to evaluate these technologies in real world situations.

Such emerging technologies need to be evaluated under stringent safety and security standards required for safety of the vehicles on the road. Evaluating these technologies requires precise simulation tools, which can provide close to real-world simulations. Existing network simulation tools are designed for evaluation of general purpose network protocols, and are not adequate to simulate the unique mobility and precise propagation models required for vehicular communication. More specifically, having the right mobility model is the fundamental requirement for simulation of vehicular networks. While some commercial traffic simulators known in the prior art provide mobility models, it is very difficult to implement any communication related protocols on these simulators due to the complexity of implementing multi-layer communication protocols.

Thus, there is a need for a system and method for simulating the propagation of radio signals including the effects of shadowing in vehicular networks.

### SUMMARY OF THE INVENTION

The present invention overcomes the deficiencies of the prior art with a system for simulating the propagation of radio signals including the effects of shadowing in vehicular networks. The system is particularly advantageous because it simulates inter-vehicle radio communication on a vehicular network including the effects of buildings and terrain on radio propagation as well as the shadow (radio propagation shadowing) effects of other vehicles. In one embodiment, the system comprises a simulation engine, a network simulator, a driving simulator, a database and a user interface module. The simulation engine is adapted for communication with the network simulator, the driving simulator, the database and the user interface module. The simulation engine simulates the propagation of communication signals between vehicles including the effects of shadowing, and also receives data from the network simulator, the driving simulator and database to generate the propagation simulation. The simulation engine outputs the results of the propagation simulation to the user interface module which translates the information into various displays. The present invention is particularly advantageous because it provides a variety of different user interfaces to show the effective range/propagation of communication signals for different conditions including vehicle locations, terrain, vehicle movements, data traffic and networks configuration. The present invention is also advantageous because the simulation engine has a flexible simulation framework with a plug-in architecture that provides interfaces to different applications and environments that allows the simulation emphasis to be modified. For example, simulation emphasis could be on network traffic, collision avoidance, or communication bandwidth.

In one or more embodiments, the present invention includes a method for simulating the propagation of signals in a communication network for vehicles including the effects of shadowing, and a method for determining communication available between one vehicle and another vehicle.

The features and advantages described herein are not all-inclusive, and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a functional block diagram of an embodiment of a system for simulating propagation of radio signals including the effects of shadowing in vehicular networks according to the present invention.

FIG. 2 is block diagram of a second embodiment of the system for simulating propagation of radio signals including the effects of shadowing in vehicular networks according to the present invention.

FIG. 3 is block diagram of a third embodiment of the system for simulating propagation of radio signals including the effects of shadowing in vehicular networks according to the present invention.

FIG. 4 is a block diagram of an embodiment of a simulation engine in accordance with the present invention.

FIG. 5 is a block diagram of an embodiment of a memory for the simulation engine of FIG. 4 in accordance with the present invention.

FIG. 6 is a flowchart of an embodiment of a process for generating a simulation of propagation of radio signals in accordance with the present invention.

FIG. 7 is a flowchart of an embodiment of a process for determining communication available between one vehicle and another vehicle in accordance with the present invention.

FIGS. 8-13 are exemplary graphical user interfaces generated by the simulation engine and a user interface module in accordance with the present invention.

### DETAILED DESCRIPTION OF PREFERRED EMBODIMENTS

A system and methods for simulating the propagation of radio signals including the effects of shadowing in vehicular networks are described below. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment,” “an embodiment” or “the embodiment’ means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### System

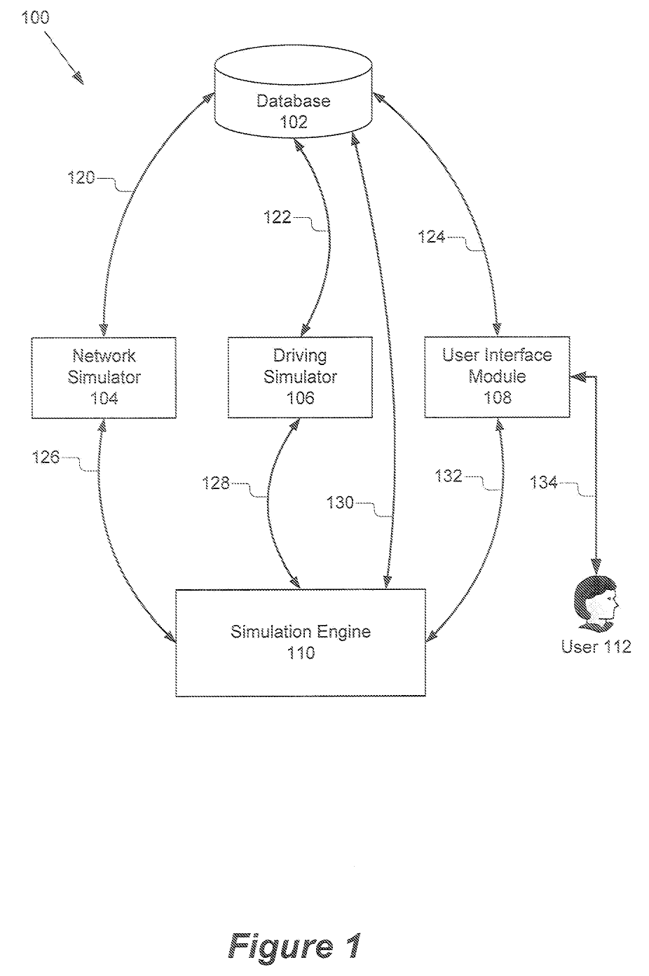

FIG. 1 shows an architectural block diagram of an embodiment of a system 100 for simulating propagation of radio signals including the effects of shadowing in vehicular networks according to the present invention. In particular, the system 100 simulates inter-vehicle or vehicle-to-vehicle radio communication that includes: 1) a dynamic and realistic vehicle control model for one or more vehicles; 2) precise network performance including precise network layer stack simulation specific to real world locations; 3) a radio wave propagation model for wireless communication characteristics specific to vehicle and location; and 4) additional information for integration into the simulation and for presentation to the user including a real street map database, 3D terrain database, 3D building database and 3D vehicle model.

The system 100 is particularly advantageous because it simulates inter-vehicle or vehicle-to-vehicle radio communication on a vehicular network including the shadow effects of other vehicles. The system 100 of the present invention simulates automotive based ad hoc mesh networks. The system 100 of the present invention has the unique ability to model and simulate communication between vehicles traveling on roads while at the same time allowing the communications themselves to affect the driving behavior of the vehicles. In other words, the driving simulation, the network simulation and the signal propagation simulation dynamically interact with each other. The system 100 of the present invention has additional advantages including: providing powerful analysis tools to simulate and analyze various communications scenarios; providing a flexible environment for testing and simulation of in which various modules and their associated parameters can be applied to the simulation; providing simulation of the communication network; providing simulation of driving behaviors and traffic patterns; allowing applications that utilize communications to be tested; and allowing importation of live vehicle data from the field for verification of performance. Furthermore, the system 100 of the present invention provides a flexible simulation framework utilizing plug-in modules that can emphasize different simulations including the driving simulation, network simulation or propagation simulation according to the application whether it is to test and evaluate safety, communication or a new technology.

The system 100 of the present invention provides a simulator for realistic evaluation of communication protocols. This is possible because the system 100 of the present invention includes: 1) precise mobility models like vehicles moving on real road network, 2) simulations of the vehicle safety based on vehicular communication and human driving behavior, 3) precise propagation models by calculating path-loss, fading, multi-path reflection and Doppler effects in vehicular communication scenarios, 4) precise network simulation models, and 5) real-time and online animation of the results.

In one embodiment, the system 100 comprises a database 102, a network simulator 104, a driving simulator 106, a user interface module 108 and a simulation engine 110. As has been noted above, the simulation engine 110 simulates the propagation of communication signals between vehicles including the effects of shadowing, and also receives data from the network simulator 104, the driving simulator 106 and database 102 to generate the propagation simulation. The simulation engine 110 outputs the results of the propagation simulation along with other simulation information to the user interface module 108 which translates the information into various displays for presentation to a user 112.

The database 102 is a conventional type for storing information. In one embodiment, the database 102 is a geographic database that provides variety of geographic information for the network simulator 104, the driving simulator 106, the user interface module 108 and the simulation engine 110. For example, the database 102 is a database server that provides the road network data, terrain data and building 3-D data for driving and network simulation. More specifically, the database 102 provides road network information, a Digital Elevation Model (DEM), and real 3D building information required to calculate the propagation models in selected city blocks (For example, Downtown San Francisco).

The network simulator 104 simulates the network protocols using mobility models created by the driving simulator 106. The network simulator 104 simulates all layers of a network stack of communication protocols and provides network statistics. The system 100 advantageously allows use of any existing network simulator for communication protocol simulation without major changes. This allows the present invention to use a rich set of pre-built models and protocols defined in those simulation tools. For example, the system 100 uses either NS-2 or a Qualnet simulation tools for communication simulation. Those skilled in the art will recognize that various other network simulation tools may alternatively be used for the network simulator 104. The system 100 supports the simulation of communications at all levels of the protocol stack including wireless propagation. The configuration of network simulation parameters can be defined using the user interface module 108. The network simulator 104 is adapted for communication with the database 102 by signal line 120 and with the simulation engine 110 by signal line 126. The simulation engine 110 controls and synchronizes the execution of the network simulator 104 with the driving simulator 106. The simulation engine 110 generates configuration and control files based on simulation settings defined by the user 112. The network simulator 104 uses these configuration files to run simulation for a predefined interval. This approach allows use of any predefined protocols in connection with the network simulator 104, whether it is NS-2 or Qualnet.

In one embodiment, the network simulator 104 also includes at least one communication plug-in module (not shown) that allows the network simulator 104 to understand the communication between any two nodes in real-time. The use of different communication plug-in modules allows the user to implement and integrate user defined communication protocols into the system 100. This is advantageous because there is no need to recompile the network simulator 104 to add new communication modules, making the addition of new communication modules very simple. Based on the communication received, the communication plug-in module can trigger changes in driving behavior. This type of interaction between driving and network simulation is unique in the system 100. The communication protocol plug-in module(s) is intended to allow users to easily develop their own application level communication protocols and interface them to the network simulator 104. The communication protocol plug-in modules are intended to interface and be used just like any other application level protocol that may exist in the network simulator 104. Once a communication protocol plug-in module has been added to the network simulator 104 that application protocol is able to send and receive messages just like any other protocol that is part of the protocol stack for a node. For example, a communication protocol plug-in module can be used to implement a publish/subscribed event dissemination broadcast protocol to efficiently disseminate information among the fast moving vehicles.

The driving simulator 106 simulates the movement of vehicles on a road network defined by the database 102. It also simulates human driving behavior and traffic to model realistic vehicle mobility. In one embodiment, the driving simulator 106 includes a model with data about different vehicle types from small vehicles such as motorcycles and small cars to large vehicles such as trucks used for transportation or buses. The driving simulator 106 will drive the vehicles to create mobility models. The unique feature in the system 100 is that the mobility model changes based on the communication messages received. This feature distinguishes driving simulator 106 from other network and traffic simulators because it can simulate the effectiveness of communication on real driving scenarios. The driving simulator 106 is designed to simulate microscopic or macroscopic driving simulation based on simulation requirements. The driving simulator 106 controls the location of vehicles as the overall simulation progresses. During the course of the simulation, the vehicle's location is determined by the driving simulator 106 and passed to the simulation engine 110 so that the vehicle's location can dynamically change based upon a wide variety of user defined criteria. The vehicle mobility model is generated by combination of environment model (speed limit, traffic signals etc.) with vehicle dynamics (acceleration and deceleration rates) model. To more realistically define the driving behavior the driving simulator 106 also uses a driver behavior model, where a driver can supersede the environment model. Based on the simulation requirement, the driving simulator 106 can load the real traffic data for highway traffic scenarios.

The driving simulator 106 is adapted for communication with the database 102 by signal line 122 and with the simulation engine 110 by signal line 128. The driving simulator 106 is also adapted to receive one or more vehicle-control plug-in modules (not shown). By using vehicle-control plug-in modules, the driving simulation 106 can dynamically change the driving behavior of individual vehicle based on the communication received from other vehicles. Use of this feature demonstrates the network protocols performance in a safety related application. The vehicle-control plug-in modules let the user 112 create custom driving behavior algorithms for the system 100. The vehicle-control plug-in modules interface to the system 100 in such a way that they can obtain wide range of information about current simulation such as road information and vehicle position, and change the vehicles driving behavior based on that state. The vehicle-control plug-in modules can also be used to access or provide information from communication plug-in modules to share information. Based on the simulation requirements, the user can develop simple to very complex vehicle-control plug-in modules and apply them to individual vehicles.

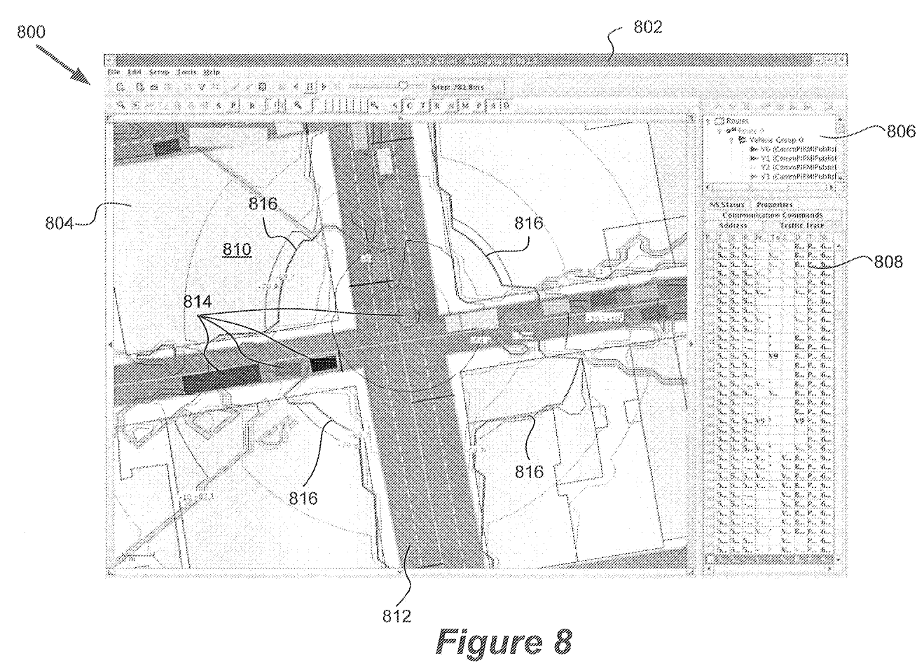

The system 100 also includes a unique user interface module 108. In one embodiment, the user interface module 108 is client software operable on any computing device. The user interface module 108 allows easy configuration of communication and driving simulation parameters as well as generates a variety of user interfaces to present radio propagation data combined with other simulation data. The user interface module 108 generates a topographical map to illustrate radio propagation. The user interface module 108 also generates another graphical user interface to shows possible vehicle to vehicle communication. Some example user interfaces generated by user interface module 108 are shown and described below with reference to FIGS. 8-13. The user interface module 108 also provides real-time and offline animation of the simulations generated by the system 100. The user interface module 108 is adapted for communication with the database 102 by signal line 124 and with the simulation engine 110 by signal line 132. The user interface module 108 is adapted for communication with the user to receive input and present data via interface 134. Example functionality provided to the user 112 by the user interface module 108 includes: configuration, initialization and controlling the network simulation; configuration and control of the driving simulation; configuration of the propagation modeling parameters; adding communication protocols and vehicle control parameters; animating the simulation based on data obtained from the simulation engine 110 and the database 102; retrieving pre-existing simulation stored in the database 102; displaying the results and statistics of a simulation; and modifying the database model as per user requirements.

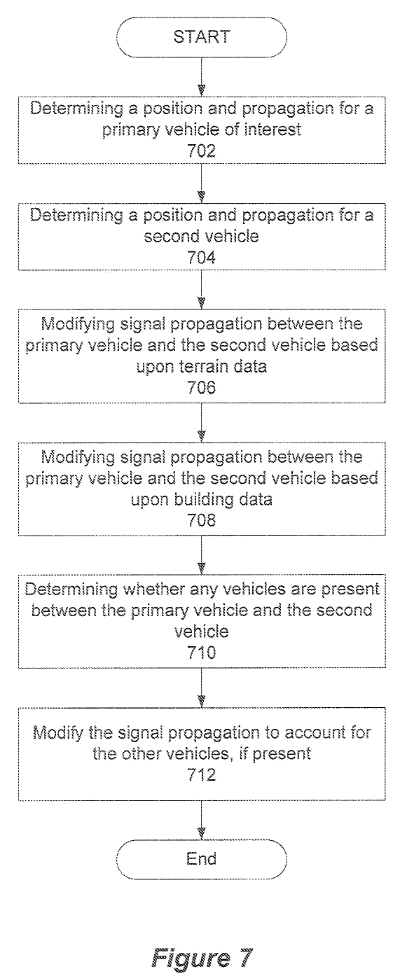

The simulation engine 110 communicates with the database 102, the network simulator 104 and the driving simulator 106; and generates propagation calculations for vehicle communication. More specifically, the simulation engine 110 performs a control, coordination and data exchange function for interacting with the database 102, the network simulator 104 and the driving simulator 106. The simulation engine 110 also functions as a simulator to model radio propagation. The present invention advantageously generates accurate propagation modeling despite the unique mobility in vehicles and the cluttered environment in which they communicate. This environment requires more specific and precise propagation models than are available in the prior art. For example, a fast moving car might cause rapid fluctuations of the amplitude and phase of the signal due to multi-path reception. The rapid mobility will also affect the Doppler Shift of the signal and thus causing random shift in the frequency modulation. The simulation engine 110 performs calculation of propagation data based on the original topography of the location, 3D data for the buildings and movement of the vehicles as will be described in more detail below with reference to FIG. 7. The simulation engine 110 advantageously provides a simulation framework with a flexible and extendable architecture to add or interface to new propagation models.

The simulation engine 110 generates propagation data based on the original topography data and the 3-D data for buildings. The simulation engine 110 modifies this part these propagation calculations based on the movement of vehicles as well as vehicles type. A particular advantage of the present invention is that the simulation engine 110 generates much more accurate propagation data by taking into consideration the shadowing effects of other vehicles on vehicle-to-vehicle communication. The simulation engine 110 includes a radio propagation module, a radio propagation model and radio propagation plug in modules that support the customized propagation calculation algorithms as per the simulation requirement. As the complexity of propagation calculation algorithms varies from very high compared to other simple simulation modules, the user can choose to either use simple propagation models or complex models or none at all based on simulation requirements. Including a detailed radio propagation model is an important aspect in evaluating the correctness of communication protocols. Especially for safety related vehicular communication, it is essential to have accurate and detailed propagation calculation models. The propagation module interacts with network simulator 104 to provide customized propagation models.

The simulation engine 110 is adapted for communication with the network simulator 104, the driving simulator 106 and user interface module 108 as has been described above. The simulation engine 110 is adapted for communication with the database 102 via signal line 130. The simulation engine 110 includes one or more propagation plug in modules that allow user to easily develop and interface customized propagation models to the network simulator 104. The propagation plug-in modules access the topography and radio obstacle information (e.g., 3D building information) from database server 102 to compute the propagation values. The propagation plug-in modules also use vehicle information (e.g., location, size and type) to calculate the shadowing effects due to vehicles (e.g., a vehicle obstructing signals from other vehicles). The propagation plug-in mechanism is advantageous because it allows the user to easily add new propagation models to the simulation. This feature also lets the user easily interface with propagation models that have already been developed. For example, a propagation plug-in module can be provided to calculate path-loss in a situation where a fast moving vehicle obstructing (Vehicle-Shadowing) the signal between a transmitting and receiving vehicle. A Log-Normal shadowing model is used as a basis to calculate the propagation loss. Because of the fast mobility of vehicles this propagation plug-in module calculates the propagation at the same instance message is transmitted. Before network simulator 104 transmits the message it requests propagation plug-in module calculate the path loss. The radio propagation plug-in module obtains the location of neighboring vehicles (that are in transmission range) and calculates the radio propagation loss due to obstructing vehicles and buildings.

The requirements for the simulation scenario will change based on type of the application and the environment the simulation is running. For example, safety application scenarios like collision avoidance should be able to emphasize more on vehicle control based on communication received. On the other hand applications like file sharing require more emphasis on communication requirements like bandwidth. Tightly coupled simulation architectures make it difficult if not impossible to change simulation emphasis based on requirement. However, the architecture described above with propagation plug-in modules, vehicle-control plug-in modules and communication protocol plug-in modules increase the adaptability of the simulator of the present invention.

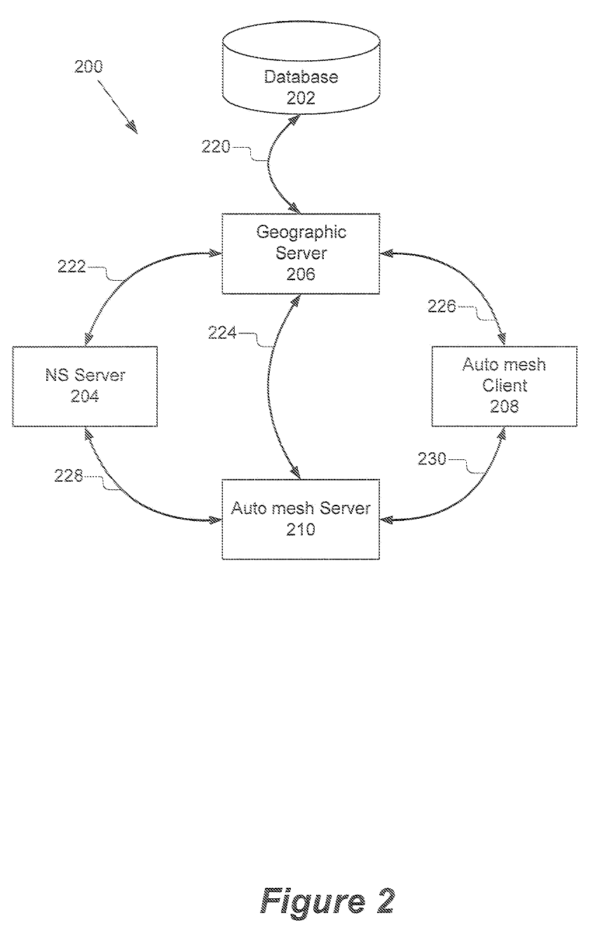

Referring now also to FIG. 2, a second embodiment of the system 200 for simulating propagation of radio signals including the effects of shadowing in vehicular networks is shown. FIG. 2 illustrates an example hardware embodiment for the system 200. In one embodiment, the system 200 includes a database 202, a network simulation server 204, a geographic database server 206, an auto-mesh server 210 and an auto-mesh client 208.

The database 202 is a conventional type used to store information. The database 202 is a relational or flat file database and is coupled by signal line 220 to the geographic database server 206. The database 202 stores information such as terrain, road and building information such as that described above with reference to database 102. The geographic database server 206 is a computing device for receiving requests for information and providing information in response. The geographic database server 206 may be a database server of a conventional type as will be understood to those skilled in the art. The geographic database server 206 is coupled by signal line 222 to the network simulator server 204, by signal line 224 to the auto-mesh server 210 and by signal line 226 to auto-mesh client 208. In one embodiment signal lines 222, 224, 226, 228 and 230 are couplings via a network such as a conventional local area network.

The network simulation server 204 is a server running simulation software to model network communication and is capable of executing various programs such as the present invention. The network simulation server 204 is coupled by signal line 228 to the auto-mesh server 210. The network simulation server 204 includes the functionality that was described above with reference to FIG. 1 for network simulator 104. The network simulation server 204 communicates with the geographic database server 206 to retrieve any needed navigational, building or terrain data. The network simulation server 204 receives data and control signals from the auto-mesh server 210.

The auto-mesh server 210 is a server running software to model and simulate driving of vehicles and radio signal propagation and is capable of executing various programs such as the present invention. The auto-mesh server 210 also coordinates and controls the network simulation server 204 and the auto-mesh client 208. In particular, the auto-mesh server 210 configures and synchronizes the network simulator, the driving simulator and the propagation simulator. The auto-mesh server 210 is coupled for communication with the geographic database server 206 via signal line 224 and with the auto-mesh client 208 via signal line 230. The auto-mesh server 210 performs the functionality of the driving simulator 106 and the simulation engine 110 described above with reference to FIG. 1.

The auto-mesh client 208 is client software operable on any type of computing device such as a personal computer. The auto-mesh client 208 is coupled by signal line 226 to the geographic database server 206. Those skilled in the art will recognize that the auto-mesh client 208 includes typical functionality for a client in a client/server architecture as well as the functionality of the user interface module 108 described above with reference to FIG. 1.

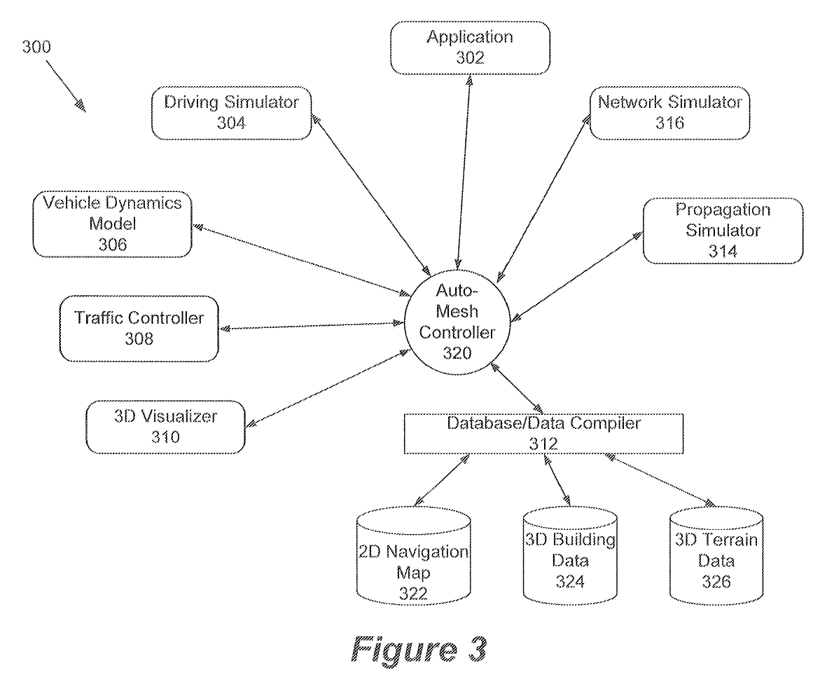

Referring now to FIG. 3, a third embodiment of the system 300 for simulating propagation of radio signals including the effects of shadowing is shown. In particular, FIG. 3 illustrates an example software/functional architecture that shows the components of the system 300 and their interaction. In the example embodiment shown in FIG. 3, the system 300 comprises an application 302, a driving simulator 304, the vehicle dynamics model 306, a traffic controller 308, a three-dimensional visualizer 310, a propagation simulator 314, a network simulator 316, an auto-mesh controller 320 and a database/data compiler 312 having two-dimensional navigational map data 322, three-dimensional building data 324, and three-dimensional terrain data 326.

The application 302 may be any one of a number of different applications to evaluate and test different aspects of network communication, radio propagation, vehicle interaction and safety. For example, an application 302 may be designed to test communication performance for given vehicular mobility; the evaluation of bandwidth, delay or other network parameters; estimation of reliability of a protocol in communication; the effectiveness of vehicle-to-infrastructure communication; or the impact of macro level traffic or congestion to reduce communication. Specific examples of applications related to safety that can be run on the system 100 include collision avoidance, emergency brake warnings, intersection traffic control, vehicle platooning, and highway merging assistance. As shown in FIG. 3, the application 302 is adapted for communication with the auto-mesh controller 320. The application 302 sends messages to the auto-mesh controller 320 to configure and run the application 302. In response, the application 302 receives messages and vehicle status information from the auto-mesh controller 320.

The driving simulator 304 is software operational on a server to implement the functionality that has been described above as the driving simulator 106 of FIG. 1. The driving simulator 304 generates vehicle location and speed information (referred to herein as “vehicle mobility information”) and is adapted for communication with the auto-mesh controller 320 to send that information. The driving simulator 304 also receives map, traffic signal and other vehicle behavior constraint information from the auto-mesh controller 320.

The vehicle dynamics model 306 is software and data operational on a server to provide information about vehicle dynamics for one or more different types of vehicles. The vehicle dynamics model 306 generates information such as speed, acceleration and other vehicle behavior constrain information that can be used by the driving simulator 304 to generate a realistic simulation of a particular vehicle's movement. The vehicle dynamics model 306 provides different information depending on the type, make and model of the vehicle. The vehicle dynamics model 306 is coupled to the auto-mesh controller 320 to provide such information that allows the auto-mesh controller 320 in turn to create a vehicle mobility model.

The traffic controller 308 is software and data operational on the server to provide information about traffic conditions. In one embodiment, the traffic controller 308 includes historical data for different traffic levels and congestion scenarios. In another embodiment, the traffic controller 308 is an interface to a system or network that is capturing real-time data of actual traffic conditions that can be output to the auto-mesh controller 320. In either embodiment, the traffic controller 308 provides real traffic data representative of actual traffic conditions that have or could exist for particular locations. The traffic controller 308 is coupled to the auto-mesh controller 320 receive information such as a map and to provide traffic data such as the status of traffic signals. The auto-mesh controller 320 also uses this real traffic data to generate the vehicle mobility model.

The three-dimensional visualizer 310 is software and data operational on the server to generate three-dimensional representations or models of buildings, terrain and vehicles. The three-dimensional visualizer 310 is adapted for communication with the auto-mesh controller 320 to receive data from the auto-mesh controller 320. In one embodiment, the auto-mesh controller 320 retrieves information from the data compiler 312 and provides it to the three-dimensional visualizer 310. Using information provided by the auto-mesh controller 320, the three-dimensional visualizer 310 generates representations that can be used by the propagation simulator 314 to simulate signal propagation and by the user interface module 108 in presenting the simulation results to the user 112. In one embodiment, the three-dimensional visualizer 310 is a graphics user interface and an animation tool as will be understood by those skilled in the art. The generation of three-dimensional orientations is particularly advantageous because in reviewing the simulation the user is able to manipulate the user interface within a three-dimensional model to better understand the obstacles that are reducing propagation of the radio signal.

The propagation simulator 314 is software operational on a server to run propagation simulations as has been described above with reference to FIG. 1. The propagation simulator 314 is adapted for communication with the auto-mesh controller 320. The propagation simulator 314 receives 3-D models of buildings, terrain and vehicles for use in the generation of the propagation portion of the simulation. The propagation simulator 314 sends propagation information such as node-to-node propagation parameters to the auto-mesh controller 320.

The network simulator 316 is software operational on the server to run the network simulation with the functionality that as has been described above as network simulator 106 of FIG. 1. The network simulator 316 is adapted for communication with the auto-mesh controller 320. The network simulator receives messages from the auto-mesh controller 320 for configuration of simulations, vehicle location, node-to-node propagation parameters and other information from the propagation simulator 314 relayed through the auto-mesh controller 320. The network simulator 314 also sends and receives messages that are representative of the status of the communication network including the different layers of the communication network and their state.

The database/data compiler 312 is software for interfacing one or more data stores. In the particular embodiment shown in FIG. 3, the data compiler 312 has access to three different data stores 322, 324 and 326. A first data store 322 includes two-dimensional navigation map information such as US Topographically Integrated Geographic Encoding and Referencing system in an independent format. A second data store 324 includes three-dimensional building data such as information from sources such as Sanborn maps or ESRI™ shape file in an independent format. Finally, a third data store 326 includes three-dimensional terrain data such as a US Digital elevation model file. The data compiler 312 is adapted for communication with the auto-mesh controller 320. Responsive to requests from the auto-mesh controller 320, the data compiler 312 provides information about roads, buildings or terrain from the data stores 322, 324 and 326. This information can then be provided by the auto-mesh controller 320 to any one of the other components needing that information for their operations.

The interaction of the auto-mesh controller 320 has largely been described above with reference to the difference components 302, 304, 3 to 6, 308, 310, 312, 314 and 316. However, it should be noted that the auto-mesh controller 320 provides a number of additional functions. Most importantly, the auto-mesh controller 320 configures and controls the execution of each of the simulators 304, 314 and 316 to synchronize vehicle movement, communication network status and signal propagation. The auto-mesh controller 320 also provides an interface to send and receive data between multiple nodes, and also provides a channel for retrieving data from multiple sources as necessary. One particular advantage of the auto-mesh controller 320 is that it provides a platform in which plug-in modules can be provided such that they communicate with the auto-mesh controller 320 along predefined protocols.

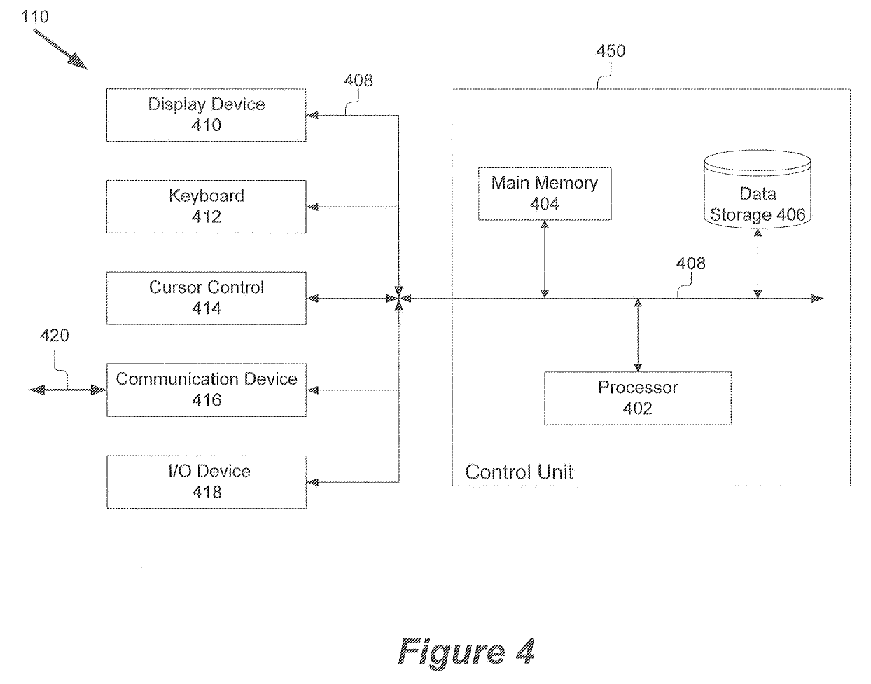

Referring now also to FIG. 4, a functional block diagram of the simulation engine 110 configured in accordance with embodiments of the present invention is shown. The simulation engine 110 preferably comprises a control unit 450, the display device 410, a keyboard 412 and cursor control 414. The simulation engine 110 may optionally include a communication device 416 and one or more input/output (I/O) devices 418.

The control unit 450 comprises an arithmetic logic unit, a microprocessor, a general purpose computer or some other information appliance equipped to provide electronic display signals to display device 410. In one embodiment, the control unit 450 comprises a general purpose computer having a graphical user interface, which may be generated by, for example, a program written in Java running on top of an operating system like WINDOWS® or UNIX® based operating systems.

Still referring to FIG. 4, the control unit 450 is shown including processor 402, main memory 404 and data storage device 406, all of which are communicatively coupled to system bus 408.

Processor 402 processes data signals and may comprise various computing architectures including a complex instruction set computer (CISC) architecture, a reduced instruction set computer (RISC) architecture, or an architecture implementing a one or more of instruction sets. Although only a single processor is shown in FIG. 4, multiple processors may be included.

Main memory 404 stores instructions and/or data that may be executed by processor 402. The instructions and/or data may comprise code for performing any and/or all of the techniques described herein. Main memory 404 may be a dynamic random access memory (DRAM) device, a static random access memory (SRAM) device, or some other memory device known in the art. The memory 404 is described in more detail below with reference to FIG. 4.

Data storage device 406 stores data and instructions for processor 402 and comprises one or more devices including a hard disk drive, a floppy disk drive, a CD-ROM device, a DVD-ROM device, a DVD-RAM device, a DVD-RW device, a flash memory device, or some other mass storage device known in the art. In one embodiment, the data storage device 406 includes web analytic statistics and data for presentation on the display device 410. In an another embodiment, the data storage device 406 is a disk array separate from the simulation engine 110 but communicatively coupled for high speed access.

System bus 408 represents a shared bus for communicating information and data throughout control unit 450. System bus 408 may represent one or more buses including an industry standard architecture (ISA) bus, a peripheral component interconnect (PCI) bus, a universal serial bus (USB), or some other bus known in the art to provide similar functionality. Additional components coupled to control unit 450 through system bus 408 include the display device 410, the keyboard 412, the cursor control 414, the communication device 416 and the I/O device(s) 418.

The display device 410 represents any device equipped to display electronic images and data as described herein. In one embodiment, the display device 410 is a liquid crystal display (LCD) and light emitting diodes (LEDs) similar to those on many conventional display system for computers to provide a display area and status feedback, operation settings and other information to the user. In other embodiments, the display device 410 may be cathode ray tube type display.

Keyboard 412 represents an alphanumeric input device coupled to control unit 450 to communicate information and command selections to processor 402. The keyboard 412 can be a QWERTY keyboard, a key pad, or representations of such created on a touch screen.

Cursor control 414 represents a user input device equipped to communicate positional data as well as command selections to processor 402. Cursor control 414 may include a trackball, a stylus, a pen, a touch screen, cursor direction keys or other mechanisms to cause movement of a cursor. In one embodiment, Cursor control 414 is a digitizer in which a touch-sensitive, transparent panel covers the screen of display device 410.

The simulation engine 110 may optionally include the communication devices 416 and one or more input/output (I/O) devices 418 such as described below.

The communication device 416 may be a network controller that links control unit 450 to a network (not shown) via signal line 420 that may include multiple processing systems. The network of processing systems may comprise a local area network (LAN), a wide area network (WAN) (e.g., the Internet), and/or any other interconnected data path across which multiple devices may communicate. The control unit 450 also has other conventional connections to other systems such as a network for distribution of files (media objects) using standard network protocols such as TCP/IP, http, https, and SMTP as will be understood to those skilled in the art. The communication device 416 in other embodiments includes a Bluetooth® transceivers, wireless transceivers, or infrared transceivers for communication along a channel 420.

One or more I/O devices 418 are coupled to the bus 408. These I/O devices 418 are part of simulation engine 110 in one embodiment. The I/O device 418 may also include audio input/output device equipped to receive audio input via a microphone and transmit audio output via speakers. Optionally, I/O audio device 418 may contain one or more analog-to-digital or digital-to-analog converters, and/or one or more digital signal processors to facilitate audio processing. In one embodiment, I/O device 418 is a general purpose audio add-in/expansion card designed for use within a general purpose computer system.

It should be apparent to one skilled in the art that the simulation engine 110 may include more or less components than those shown in FIG. 4 without departing from the spirit and scope of the present invention. For example, the simulation engine 110 may include additional memory, such as, for example, a first or second level cache, or one or more application specific integrated circuits (ASICs). Similarly, additional components may be coupled to control unit 450 including, for example, an RFID tag reader, digital still or video cameras, or other devices that may or may not be equipped to capture and/or download electronic data to control unit 450. One or more components could also be eliminated.

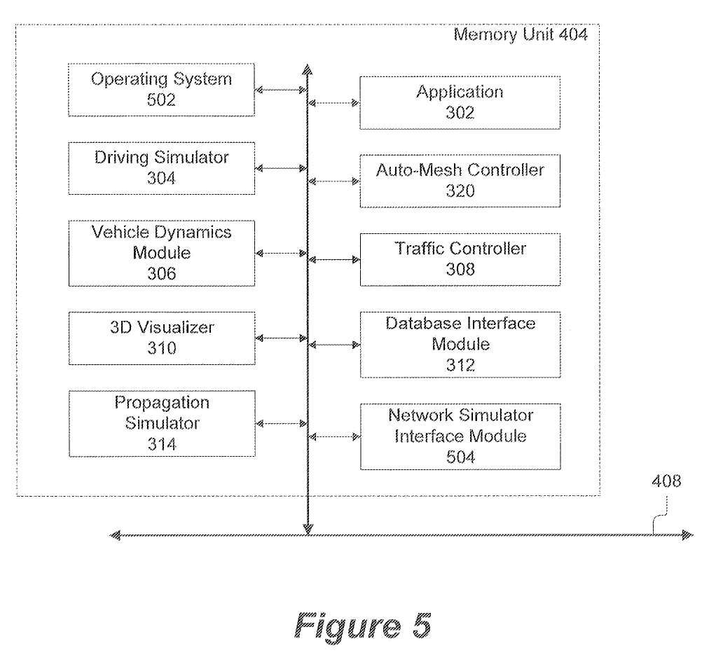

FIG. 5 is a block diagram of one embodiment of the memory unit 404 for the simulation engine 110. The memory unit 404 preferably comprises: an operating system 502, the application 302, the driving simulator 304, the auto-mesh controller 320, the vehicle dynamics module 306, the traffic controller 308, a three-dimensional visualizer 310, the propagation simulator 314, and a data compiler or interface module 312, and a network simulator interface module 504. For convenience and ease of understanding like reference numbers are used to represent like components 302, 304, 305, 308, 310, 312 and 314 in this figure having the same or similar functionality to that described above for previous figures. Since those components were described above in detail that description will not be repeated here. Those skilled in the art will recognize that the memory 404 also includes buffers for temporarily storing data. The memory unit 404 stores instructions and/or data that may be executed by processor 402. The instructions and/or data comprise code for performing any and/or all of the techniques described herein. These modules 503, 302-314 and 504 are coupled by bus 408 to the processor 402 for communication and cooperation. Those skilled in the art will recognized that while the present invention will now be described as modules or portions of a memory unit 404 of the simulation engine 110, the modules or portions thereof may also be stored in other media such as permanent data storage device 406.

The operating system 502 is one of a conventional type such as WINDOWS®, SOLARIS® or a LINUX® based operating system.

The network simulator interface module 504 includes software and routines for retrieving and sending data to the network simulation server 204 and/or network simulator 316 which may be operational on that server 204. The network simulation interface module 504 sends control signals and data to control the operation of the network simulator 316. The network interface module 504 also receives status and other data from the network simulator 316 which it processes and sends to the auto-mesh controller 320. The network interface module 504 is coupled to the auto-mesh controller 320.

### Methods

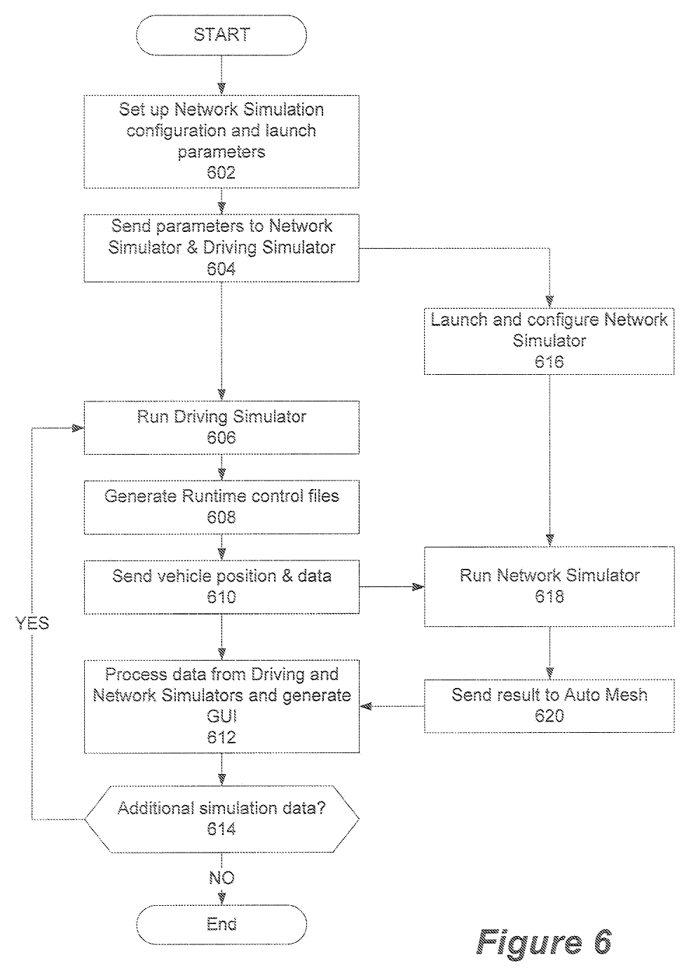

Referring now to FIG. 6, an embodiment of a process for generating a simulation of propagation of radio signals in accordance with the present invention is shown. The method begins by retrieving simulation configuration and launch parameters and setting up 602 a network simulation with those parameters. The method then sends 604 the parameters to the network simulator 316 and the driving simulator 304. The information sent to the network simulator 316 includes configuration files, launch files and initial control files. This effectively begins two separate simulations in parallel, a first simulation performing a network simulation and a second performing a driving simulation. Once initiated, these processes operate independently being synchronized by the auto-mesh controller 320.

One of the processes managed by the auto-mesh controller 320 is the operation of the driving simulator 304. After step 604, the method runs 606 the driving simulation. This includes the generation 608 of run-time control files. The driving simulator 304 provides 610 its output, namely vehicle position and other data, to the network simulator 316 as input. In one embodiment, the auto-mesh controller 320 sends run-time control files from the driving simulator 304 to the network simulator 316. The driving simulator output is also provided to the propagation simulation 314.

The auto-mesh controller 320 processes 612 information from the driving simulator 304 and the network simulator 316. The auto-mesh controller 320 also receives information from the propagation simulator 314 and processes that information as well. These three sources of information are processed 612 by the auto-mesh controller 320 to generate the novel user interface that shows signal propagation as well as other information as will be described below in more detail with reference to FIGS. 8-13. While the processing of information by the propagation simulator 314 has been described as a separate step in line with the processing done by the driving simulator 316, it was simply described here for consistency with the hardware architecture described above with reference to FIG. 2. Those skilled in the art will recognize that in an alternate embodiment there could be four parallel processes; one process which includes the steps of FIG. 6 relating to control by the auto-mesh controller 320, one process for running the driving simulator, one process for running the propagation simulator and one process for running the network simulator.

Once the information has been processed by the auto-mesh controller 320 and presented to the user with the GUI of the present invention, the process continues to determine 614 whether simulations that need to be performed. If not the method is complete and ends. However, if there are additional simulations that need to be run method returns to step 606 to perform those simulations.

The other process performed in parallel is the operation of the network simulator 316. After step 604, the process begins by launching and configuring 616 the network simulator 316. Once it has been launched, the network simulator 316 executes 618 the simulation based on information that it has received. In addition to data sources normally provided, the network simulator 316 also receives vehicle position and data from the driving simulator 304 as described above. This information is processed 618 along with other simulation data by the network simulator 316. At different times during the operation of the network simulator 316, the network simulator 316 sends 620 the results of simulation to be auto-mesh controller 320. In one embodiment, this information is sent by sending run-state files and network simulation result files from the network simulator 316 to the auto-mesh controller 320. Those skilled in the art will recognize that the overall simulation is greatly improved by the exchange of information between the driving simulator 304 and the network simulator 316 separate apart from the additional simulation related to the propagation.

Referring now to FIG. 7, an embodiment of a process for determining communication available between one vehicle and another vehicle in accordance with the present invention is shown. In order to provide the simulation, the method of the present invention coordinates the simulation of vehicle movement (driving simulation), network communication conditions (network simulation) and signal propagation (propagation simulation). Additionally, the propagation simulation is enhanced to account for shadowing effects of buildings and other vehicles. This is accomplished by performing the method for determining communication available between one vehicle and another vehicle. This method can be repeatedly performed for different vehicles to generate the possible communication links available and their characteristics. The method begins by determining 702 a position and propagation characteristics for signals from a primary vehicle of interest. Then the method determines 704 a position and propagation characteristics for signals for a second vehicle. Next, the method modifies 706 the signal propagation characteristics between the primary vehicle and the second vehicle based upon terrain data. For example, terrain data is retrieved from the data store 326 by the auto-mesh controller 320 and provided to the propagation simulator 314. Next the method modifies 708 the signal propagation characteristics between the primary vehicle and the second vehicle to account for building data. This can be done in a similar fashion to step 706, but using data store 324. The method then determines 712 whether there are any other vehicles are present between the primary vehicle and the second vehicle. If so, the signal propagation characteristics between the primary vehicle and the second vehicle to account for any other vehicles found in step 712. This method is particularly advantageous because it also the simulation to account for the shadowing effect of the terrain, buildings and other vehicles. Since the driving simulator modifies the primary vehicle position, and other vehicles are moving, the simulation is greatly improved when such shadow effects are simulated.

### Graphical User Interface

Referring now to FIGS. 8-13, example graphical user interfaces (GUIs) in accordance with embodiments of the present invention are shown. FIGS. 8-13 show the GUI in different stages of interacting with the user 112. The GUIs of the present invention are particularly advantageous because they provide an interface that presents a unified view of: the driving simulation, network simulation, and shadowing effects, as well as representation of the real world locations at which the simulation is run.

FIG. 8 shows a graphical representation of a window 802 showing the GUI 800 of the present invention. FIG. 8 illustrates one example of the unified GUI 800 for presenting data from multiple simulations in accordance with the present invention. The GUI 800 is possible in part because the auto-mesh controller 320 synchronizes the operation of the multiple simulations. As can be seen in FIG. 8, the upper portion of the window 802 includes tool bars, menus and other buttons for controlling the different simulations. These tool bars and buttons allow the user to easily configure and editing of the databases. They also allow editing of the parameters for running any one or all of the simulations. These inputs and controls are of a conventional type for controlling display attributes and information included in the GUI 800. The GUI 800 also includes a primary display region 804 in which a view of the simulation is presented. A second display region 806 is provided to display data and/or parameters relating to the driving simulation. A third display region 808 is provided to display data and/or parameters relating to the network simulation. In one embodiment, each of these display regions 806 and 808 include tools for control, tabs or other display mechanisms for partitioning the data. While the regions 804, 806 and 808 have been shown with particular locations, color schemes and organization, those skilled in the art will realize that these are provided only by way of example and in alternate embodiments a variety of different display formats, organization schemes and color schemes may be used for this GUI 800 and the other GUIs of the present invention.

A key area of the GUI 800 is the primary display region 804. The primary display region advantageously has the capability to present data from multiple simulations and other data sources simultaneously. In one embodiment, the primary display region 804 includes static data describing the terrain 810, building data 810 and a road network 812. In one embodiment, terrain data 810 is shown using color coding or other visual emphasis such as shading or other effects known to those skilled in the art. The building data 810 is shown with lines outlining the footprint of buildings. The primary display region 804 also includes one or more vehicles 814 shown generally as colored rectangular blocks and displays their movement in accordance with the output of the driving simulation. In this embodiment, the propagation simulation is shown in the GUI 800 by topographical lines 816 color coded to shown the extent of signal propagation from a selected vehicle 814 near the center of the primary display region 804.

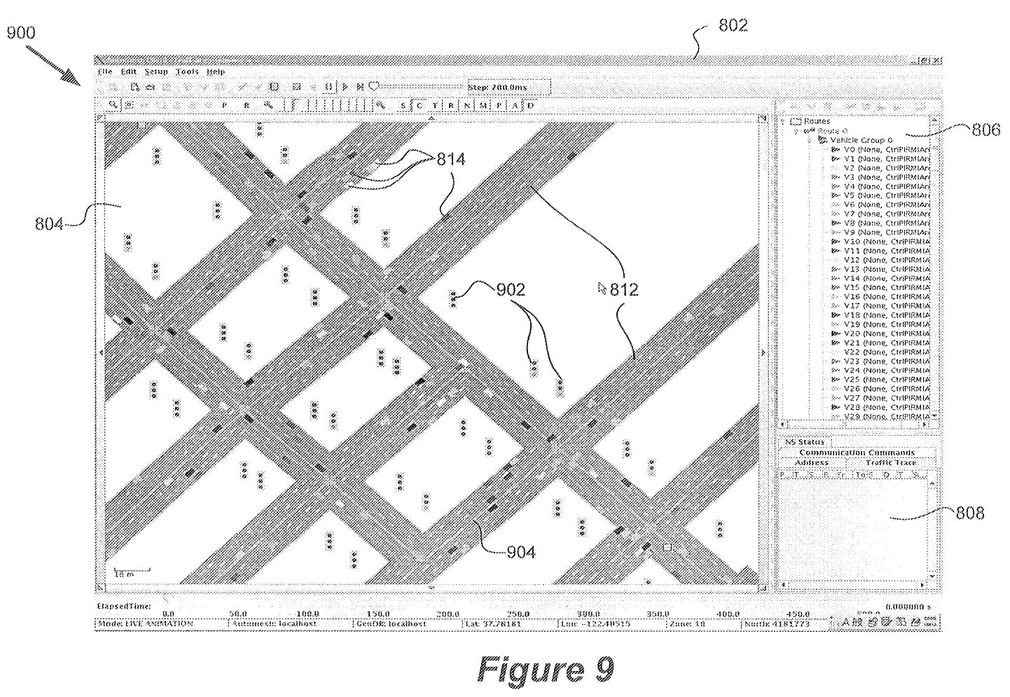

FIG. 9 shows a graphical representation of a window 802 showing another embodiment for the GUI 900 of the present invention. FIG. 9 illustrates one example of the unified GUI 900 for presenting data with an emphasis on the driving simulation data. The GUI 900 includes the window 802 including the primary display region 804, the second display region 806 for driving simulation data and the third display region 808 for network simulation. Since this view emphasizes driving simulation, there is no network simulation data shown in the primary display region 804, and thus the third display region 808 also includes no data. The primary display region 804 continues to show road network data 812, vehicles 814 and movement of the vehicles on the road network 812. The primary display region 804 show realistic vehicle mobility of each vehicle based on traffic, speed limit, road conditions and human reaction times. Since this view emphasizes driving simulation, there is also added information about the driving simulation including icons 902 for the traffic signals indicating their status. There are also emphasis lines 904 showing the general congestion and flow of the traffic.

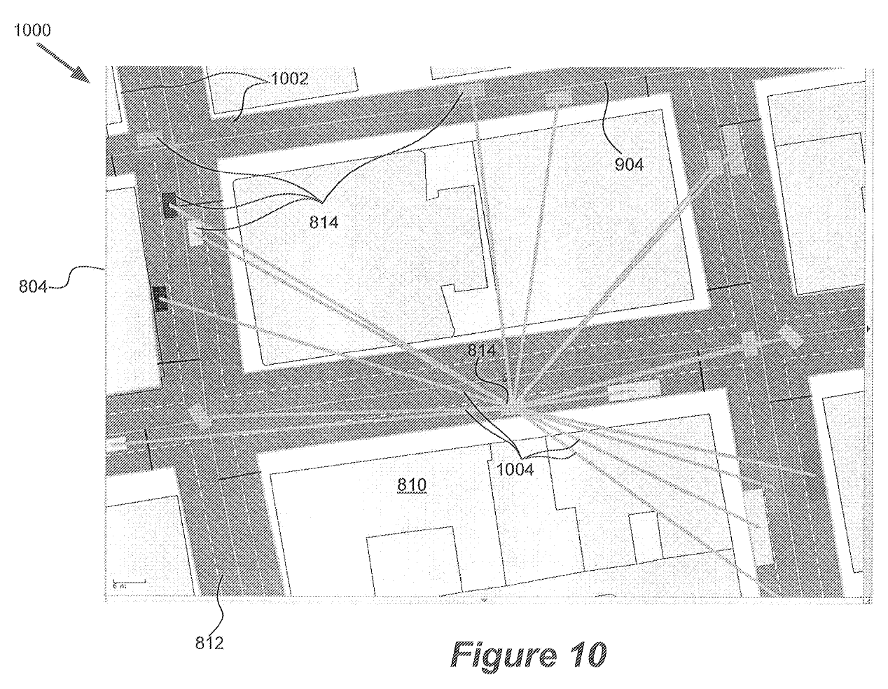

FIG. 10 shows a graphical representation of the primary display region 804 of another embodiment for the GUI 1000 of the present invention. In this embodiment, the primary display region 804 shows a combination of driver simulation results and signal propagation simulation results. The primary display region 804 includes building data 810, road network data 812, vehicles 814 and their movement similar to the other interfaces described above. This embodiment of the GUI 1000 also shows driving simulation data in terms of emphasis lines 904 showing the general congestion and flow of the traffic, and traffic signals 1002 represented in this case by colored lines. This embodiment of the GUI 1000 also shows signal propagation from a vehicle 814 to other vehicles as represented by lines 1004 reflecting messages that are delivered between the vehicle of interest and other vehicles with which it can communicate. In this embodiment, the propagation values in the simulation are not modified to take into consideration the effects of shading and the movement of vehicles.

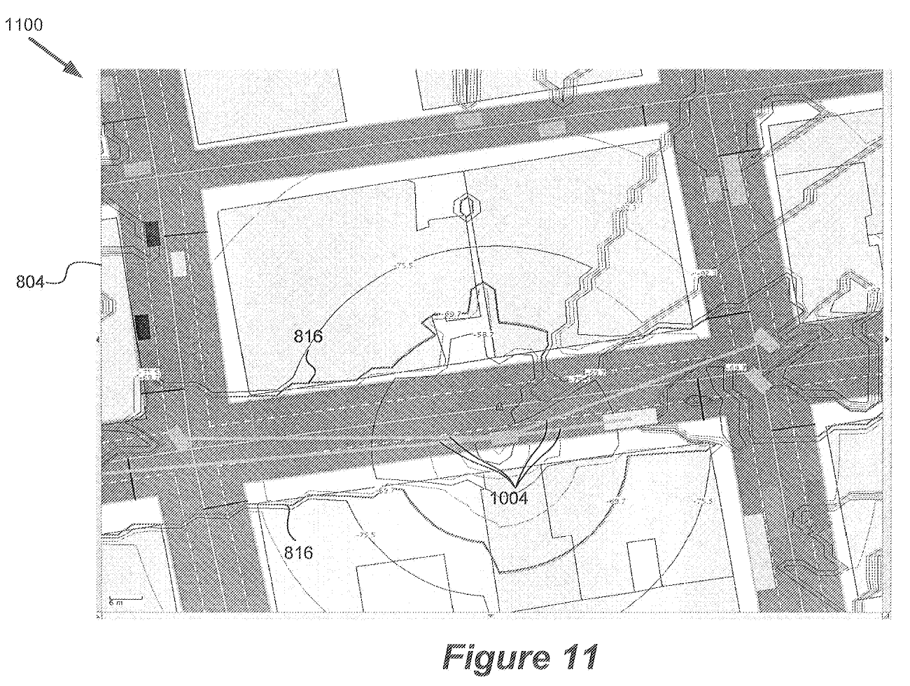

FIG. 11 shows a graphical representation of the primary display region 804 of another embodiment for the GUI 1100 of the present invention. The primary display region shown in FIG. 11 is very similar to that of FIG. 10 and again provides a unified display of the driving simulation, the terrain and road data, and the propagation simulation. However, in this embodiment which emphasizes the propagation simulation, the propagation range of the vehicle 814 is shown with both topographical lines 816 as in FIG. 8 and line connectors 1004 as in FIG. 10. More importantly, the propagation simulation includes the effects of shadowing from buildings, terrain and other vehicles. As can be seen by comparing the number of lines 1004 between vehicles in FIG. 10 verses FIG. 11, the actual signal propagation range when the effects of shadowing from buildings, terrain and other vehicles is dramatic. In the simulation of shown in FIG. 10, the user 112 is led to the wrong conclusion that messages are deliver and received by many other vehicles. As compared with FIG. 11, that shows that in fact only four other vehicles receive the message due to signal propagation limitations caused by buildings and terrain. Thus, the present invention provides a simulation that more closely reflects actual real world conditions. Those skilled in the art will recognize that based on the simulation of most of interest a variety of permutations of attributes of the above GUIs can be combined. In yet another embodiment, the display attributes are selectable by the user such that the user may select with attributed, regardless of the simulation from which they are derived may be presented in a single user interface.

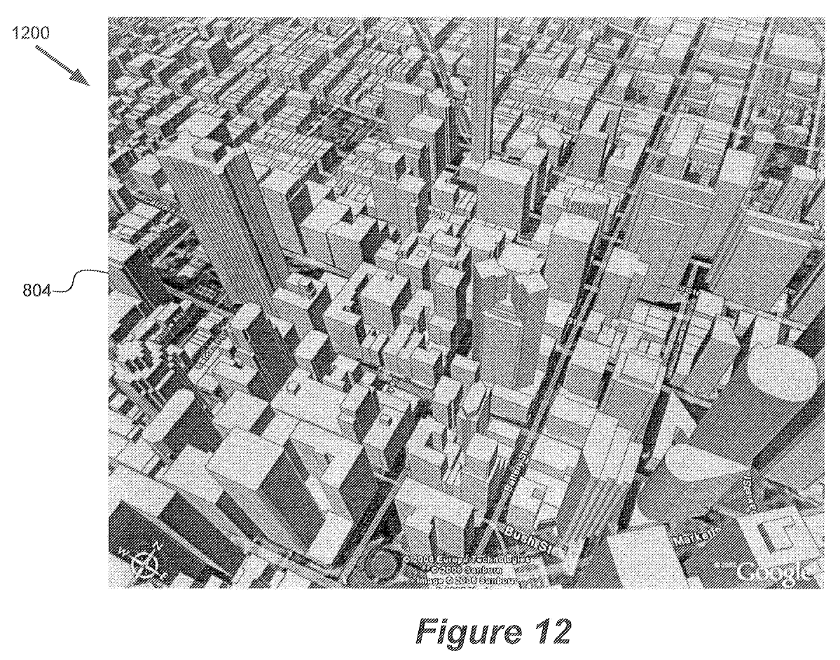

FIG. 12 shows a yet another graphical representation of the primary display region 804 of another embodiment for the GUI 1200 of the present invention. FIG. 12 illustrate how the GUI 1200 of the present invention can also be switched to show terrain and 3D rendering of building with no other simulation data. Such an interface can be used or toggled between to view the underlying location attributes. This is particularly useful where the propagation simulation does not match the user's expectations.

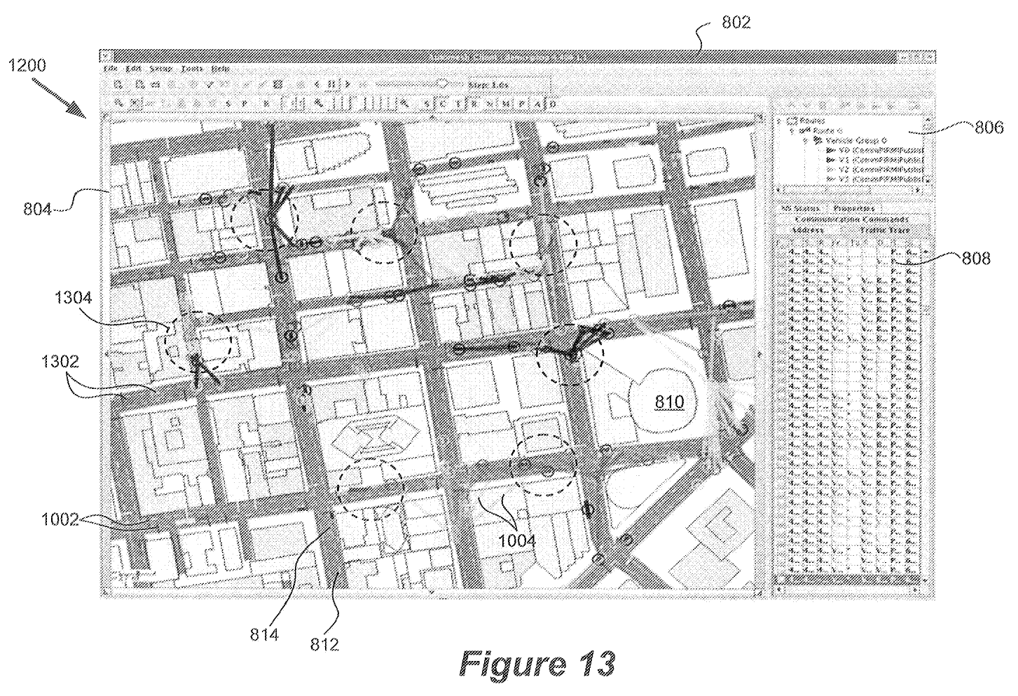

FIG. 13 shows a graphical representation of a window 802 showing another embodiment for the GUI 1300 of the present invention. FIG. 13 illustrates a fully unified an animated GUI 1300. The GUI 1300 is similar to those previously described above with reference to FIGS. 8-12. The GUI 1300 includes the three region 804, 806 and 808 division of the window 802. The GUI 1300 also presents the building data 810, road network 812, vehicles 814, traffic data 1002 and radio propagation information 1004 in a manner similar to that which has been described above. Notable differences include a differentiation between stationary vehicles 814 and moving vehicles 1302. The GUI 1300 presents moving vehicles 1302 with a different symbol such as a circle including a rectangle. The GUI 1300 also provides animation in terms of expanding and contracting hyphenated circles 1304 to show order and signal duration for the transmission and receipt of events and messages. For example in one embodiment, safety related messages may be called out with such visual effects as specified by the user.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Accordingly, the disclosure of the present invention is intended to be illustrative, but not limiting, of the scope of the present invention, which is set forth in the following claims.

1. A system for simulating the propagation of radio signals from a vehicle, the system comprising:
a driving simulator for simulating movement of a vehicle and outputting vehicle mobility information;
a network simulator for simulating communication in a network and outputting communications network information; and
a simulation engine for simulating propagation of signals, the simulation engine coupled to control operation of the driving simulator and the network simulator and to receive the vehicle mobility information and the communications network information, the simulation engine using the vehicle mobility information and the communications network information in simulating the propagation of signals.

2. The system of claim 1 wherein the driving simulator simulates traffic, human driving behavior and vehicle type to model realistic vehicle mobility responsive to receipt of a message.

3. The system of claim 1 wherein the driving simulator is adapted to receive a vehicle-control plug-in module for dynamically changing driving behavior of an individual vehicle based on communication received from other vehicles.

4. The system of claim 1 wherein the network simulator simulates network protocols using the vehicle mobility information and the network simulator is coupled to the driving simulator.

5. The system of claim 1 wherein the network simulator is adapted to receive a communication plug-in module that allows the network simulator to understand the communication between any two nodes in real-time.

6. The system of claim 1 wherein the simulation engine controls the network simulator and the driving simulator such that their operation is synchronized.

7. The system of claim 1, wherein the simulation engine comprises a controller for performing control, coordination and data exchange with the database, the network simulator and the driving simulator.

8. The system of claim 1, wherein the simulation engine simulates propagation of signals including an effect of shadowing from vehicle mobility information and radio obstacle information.

9. The system of claim 1, wherein the simulation engine is adapted to receive a propagation plug-in module to access topography and radio obstacle information.

10. The system of claim 1 further comprising a database storing one from the group of terrain data, road data and building data.

11. The system of claim 1 further comprising a user interface module for generating and presenting a graphical user interface that includes a unified view of driving simulation, network simulation, and propagation simulation with shadowing effects.

12. A method for simulating propagation of radio signals for a vehicle, the method comprising:
simulating movement of a vehicle to generate vehicle mobility information;
simulating communication in a network to produce communications network information; and
simulating propagation of signals using the vehicle mobility information and the communications network information, the simulation including an effect of shadowing calculated from vehicle mobility information and radio obstacle information.

13. The method of claim 12, wherein the simulating movement and simulating communication are coordinated and controlled by a controller.

14. The method of claim 12, further comprising the step of providing the vehicle mobility information for use in simulating communication.

15. The method of claim 14, wherein the vehicle mobility information includes one from the group of vehicle location, vehicle type, vehicle speed, vehicle direction, traffic, traffic signals, vehicle dynamics, speed limit, road conditions and human reaction times.

16. The method of claim 12, further comprising the step of providing the communications network information for use in simulating movement of the vehicle.

17. The method of claim 12, further comprising retrieving one from the group of terrain data, building data and vehicle data from a database and wherein the step of simulating propagation of signals use information from the retrieving step.

18. The method of claim 12 further comprising the step of presenting the simulated propagation signals.

19. The method of claim 18 wherein the step of presenting also presents the simulated movement of the vehicle.

20. The method of claim 18 wherein the step of presenting also presents a simulated state of communication in the network.

21. A method for determining available communication between a first vehicle and a second vehicle for simulating signal propagation, the method comprising:
determining a position for the first vehicle;
determining a position for the second vehicle;
determining a propagation characteristic between the first vehicle and the second vehicle; and
modifying the propagation characteristic based upon obstacle information.

22. The method of claim 21 wherein the obstacle data is building data or terrain data.

23. The method of claim 21 further comprising:
determining whether there is a third vehicle between the first vehicle and the second vehicle; and
modifying the propagation characteristic to account for a position of the third vehicle.
